(19) United States
(12) Patent Application Publication
(10) Pub. No.: US 2004/0052501 A1
(43) Pub. Date: Mar. 18, 2004

(54) Video event capturing system and method

(76) Inventor: Eddy C. Tam, Charlotte, NC (US)

Correspondence Address: Adams, Schwartz & Evans, P.A., 2180 Two First Union Center, Charlotte, NC, 25282, US

(21) Appl. No.: 10/295,124

(22) Filed: Nov. 15, 2002

Related U.S. Application Data
(60) Provisional application No. 60/410,099, filed on Sep. 12, 2002.

(51) Int. Cl. H04N 5/76; H04N 5/225

(52) U.S. Cl. 386/46; 386/117

(57) ABSTRACT

A process monitoring and event capturing system, including at least one video detector for monitoring a process and outputting a video signal and at least one event signal representing an event condition of the process being monitored. A recorder records the video signal and the event signal in a digital video file of a digital storage device having a predetermined data structure. The video file is structured to include at least one event feature data structure at the end of the video file for storing the event signal representative of the captured event condition. The digital storage device includes a temporary data file for storing video segments for examination by the user. The file format structure stores event data from the end of the data file forward in reverse order, permitting additions of data without affecting the previous file structure.

### TECHNICAL FIELD AND BACKGROUND OF THE INVENTION

This invention relates generally to an event capturing system and method. Event capturing systems and methods are widely used for capturing video images of random events in a manufacturing or other environment. Examples of events include excessive or insufficient pressure, incorrect positioning of parts, damage to conveyor systems or manufactured products and the like. These systems typically operate in a monitoring mode during which video images of the environment are recorded until such time as an event occurs within the environment. Upon the occurrence of an event, the video image of the event is thus recorded, or “captured.” After the event is captured, the video image of the event may be replayed so that the event can be analyzed.

Event capturing systems and methods may be classified into two major categories—analog video recording systems and high speed, solid state, fast frame recorders. The analog video recording systems record video onto magnetic tape in either slow or high speed formats. These systems typically require the recording of a large number of video images to insure that pre-event images are captured. Once an event occurs, the magnetic tape is linearly searched, often manually, for the occurrence of the event on the magnetic tape. The tape is played in reverse to obtain the desired number of pre-event video images, and played in forward mode to obtain the desired number of post-event video images. The tape is edited in order to review only the desired portion of the video tape. Individual frames of the video images are converted to digital images or negatives in order to print hard copies of the individual frames. High speed analog video recording systems generally are expensive, and are capable of recording for only brief periods of time on the order of a few seconds.

High speed, solid state, fast frame recorders record video at high speed and store the video images in a digitized format directly in solid state memory or on a magnetic disk drive. Digital video recording removes practically all effect of recording and playback, and provides the quality of direct, live video pickup with added distortion, noise and flutter. Storage in digital form allows a wide variety of analysis and evaluation as well as endless editing and copying techniques. As a result, the video images can be replayed at slower speeds. The images are recorded in memory in a first-in first-out (“FIFO”) format resulting in continuous recording of the video images in a circular fashion, often referred to as a “ring buffer”, with the oldest images being overwritten by the newest images. Images are continuously recorded in a logical circular memory during monitoring until an event occurs. Once the event occurs, the system records the post-event video images in a circular fashion based on a predetermined delay. As a result, the number of pre-event video images is a function of the number of post-event video images. Therefore, the number of pre-event video images is directly related to the total amount of memory available.

Digital data is stored according to any one of several predetermined formats. While terminology varies, digital data is typically stored in logical defined and addressed areas called, for example, frames, blocks, segments or chunks. Within such areas is stored digital data representative of video and audio information together with addressing, error detection or correction data, and the like.

One example of a computer based event capturing system is disclosed in U.S. Pat. No. 5,150,436 to Blessinger. The solid state, fast frame recorder disclosed by Blessinger records images of an event at a fast frame rate and plays back the images at a slower frame rate to facilitate analysis of the event. The fast frame recorder has a solid state memory capable of continuously recording an event in a circular format until an external trigger terminates recording. The number of images recorded before and after the triggering event may be varied. However, the number of frames recorded before and the number of frames recorded after the triggering event are related in that the total number of frames is fixed and cannot be any greater than the total number of frames capable of being recorded in the circular memory at any one time. The external trigger in the Blessinger system stops storage of image frames in solid state memory upon detection of a physical phenomena unique to the event being recorded. By delaying the signal to stop recording, image frames before and after the triggering event may be stored. As a result of being able to vary the delay in recording, Blessinger allows the capture of a random occurring event. However, the Blessinger system can capture only a single event.

Another example of an event capturing system is disclosed in U.S. Pat. No. 5,034,811 to Palm. This solid state motion analysis system stores digitized image frames in solid state memory. This system compares selected image frames produced by a solid state imaging device to identify the occurrence of a change in a characteristic between particular image frames. This process is often referred to as “machine vision.” A first frame is set as a standard. If a change in the image characteristic is determined between subsequent frames and the standard frame, a trigger signal is produced to alter the mode of operation of the motion analysis system in order to capture a desired event. As a result, the trigger signal causes the solid state memory to either begin or stop recording image frames produced by the solid state imager.

Another example of an event capturing system is disclosed in Specification No. GB 2250156A. A series of video camera inputs are digitally encoded and passed to a solid state image buffer that normally operates in a cyclic mode with the image data passing continually through it. When any one of a series of intrusion detectors is triggered by an event, the operation of the buffer is latched to retain a set of successive images that were acquired prior to the event, and a set of successive post-event images. Post-event images may also be recorded in a video tape recorder in order to extend the period of post-event images.

The invention disclosed in this application relates to a PC based digital recording system designed for industrial and manufacturing use. In the record mode, the system continuously records multiple streams of video and stores the video footage in a ring buffer. The size of the ring buffer may vary widely, limited only by the size of the hard drives used. The oldest video footage in the ring buffer is overwritten by the latest footage. When an “event” occurs, the system receives a trigger and the video footage before and after the event is transferred out of the ring buffer and stored in another logical location on the system's hard drive. An event time stamp, i.e., the time when the system received the trigger, is also stored in the video footage. A separate text-based file is generated to coordinate the playback of multiple video segments. By “event” is meant any condition, occurrence, behavior or characteristic which is sensed as a deviation from a standard. For example, on a processing line video cameras may capture video data and transmit the data to a “machine vision” software program which compares frames of video data with a standard defined within the software. The “standard” is a “non-event”, meaning that so long as the frames of video data fall within the standard, no event is detected and no trigger is transmitted to the system. Examples of conditions or occurrences which may be utilized in the system according to the invention include changes in gray scale level intensity or distribution, motor speed, pressure, roll tension or any other condition that is capable of being detected and converted to digital data. The underlying event capturing system is disclosed in European Patent No. EP 0 898 770 B1, incorporated herein by reference.

One preferred digital data storage format is a Microsoft standard AVI (audio/video interleave) format. The video data is compressed with the DV compression standard. Other video file forms (e.g. Apple QuickTime) and compression standards (e.g. MPEG or MJPEG) can be used as well. Both NTSC (60 fields per second) or PAL (50 fields per second) are supported in this system.

A line scan or high-speed camera can also be used to capture the video footage. A wireless transmitter can be connected to the camera and a receiver connected to the computer for wireless transmission of the digital signal. This is particularly useful in applications where frequent repositioning of the cameras is necessary, where the cameras are in hazardous areas or where access is difficult. A fiber optic connection can also be used to connect the camera and the computer over a long distance.

During playback, the user is presented with a screen of multiple video windows, depending how many video cameras are installed with the system. When the program loads the event, the frame to be rendered at each window is the frame marked by the event time stamp. The program uses the event time stamp on each frame of the video segment to coordinate the playback of the multiple video segments. For example, the user can play the video files in reverse from the event mark in order to examine the video footage at exactly the same time as it occurred. The user can also sequence from one camera location to a second location based on the separation in number of frames between the two cameras. In this way each video window will render the same object as it travels from one camera position to subsequent positions. This feature is particularly useful for web-based or conveyer-based operations where a large number of cameras are used. With time-coordinated play between each camera, the user can quickly identify a few key frames from several long video segments. In many medium and high-speed manufacturing and packaging situations where users are required to examine multiple video files frame-by-frame, camera coordination can result in more accurate analysis and a substantial saving of time.

### SUMMARY OF THE INVENTION

Therefore, it is an object of the invention to provide a digital recording system that permits accurate and rapid analysis of events captured and recorded for later use.

It is another object of the invention to provide a digital recording system that permits the addition of data structures to the digital video data in a single file, thus improving data transportability.

It is another object of the invention to provide a digital recording system that permits new data structures to be added to the digital video file at any time while maintaining backward compatibility with earlier systems and data structures.

It is another object of the invention to provide a digital recording system wherein data structures are added to the end of a pre-defined data structure and read in reverse, back-to-front order, whereby the original data file structure is not affected.

It is another object of the invention to provide a digital recording system wherein data structures are added to the end of a pre-defined data structure and the modified data structure is read in reverse, back-to-front order, whereby the modified video file retains its original integrity and can be read in any software video playback program that support the original file format.

It is another object of the invention to provide a digital recording system wherein user-selected video segments from multiple video sources are stored in a temporary data file and the user is permitted to examine all or specified ones of the video segments in a sequenced manner in the same manner as if reviewing an actual event file (with full camera coordination, event synchronization and sequencing from one camera to another camera).

It is another object of the invention to provide a digital recording system wherein user-selected video segments from multiple video sources are stored in a temporary data file and the user is permitted to examine all or specified ones of the video segments at the same point in time.

It is another object of the invention to provide a digital recording system wherein any number of data structures can be added to the file.

It is another object of the invention to provide a digital recording system wherein a single file can be created with video and non-video data blended together to eliminate the complexity of managing multiple files and to enhance file transportability.

It is another object of the invention to provide a digital recording system wherein new data features can be added to the file structure at any time while maintaining backward compatibility.

It is another object of the invention to provide a digital recording system wherein user-selected video segments from multiple video sources are stored in a temporary data file and the user is permitted to examine all or specified ones of the video segments in a sequenced manner in the same manner as if reviewing an actual event file with full camera coordination, event synchronization and sequencing between cameras.

It is another object of the invention to provide a digital recording system wherein user-selected video segments from multiple video sources are stored in a temporary data file and the user is permitted to examine all or specified ones of the video segments at the same point in time.

These and other objects of the present invention are achieved in the preferred embodiments disclosed below by providing a process monitoring and event capturing system, comprising at least one video detector for monitoring a process and outputting a video signal and at least one event signal representing an event condition of the process being monitored. A recorder records the video signal and the event signal in a digital video file of a digital storage device having a predetermined data structure. The video file includes a file header at the front of the file for identifying the file format of the video file, a plurality of chunk headers for identifying the beginning and end of a plurality of frame segments within the video file for storing the video signal, and at least one event feature data structure at the end of the video file for storing the event signal representative of the captured event condition.

According to one preferred embodiment of the invention, the video file includes a plurality of event feature data structures at the end of the video file.

According to another preferred embodiment of the invention, a plurality of event feature data structures are positioned in the video file in time-reversed back-to-front order for permitting additional event feature data structures to be added to the file without alteration of the pre-existing file structure.

According to yet another preferred embodiment of the invention, a plurality of digital video cameras is positioned sequentially along a processing line.

According to another preferred embodiment of the invention, a plurality of analog video cameras and an analog-to-digital converter are provided for converting an analog signal from each of the video cameras into a digital file format for being recorded in the digital storage device.

According to yet another preferred embodiment of the invention, the digital storage device includes a temporary data file for storing video segments for examination by the user.

According to yet another preferred embodiment of the invention, the video segments are stored in a sequence corresponding to the sequence of event recording for allowing the user to examine one or more of the video segments in the same sequence as the process.

According to yet another preferred embodiment of the invention, video segments from multiple video sources are stored in a sequence corresponding to the sequence of event recording for allowing the user to examine one or more of the video segments at a single point in time of the process.

According to one preferred embodiment of the invention, the event signal is a non-video signal.

According to another preferred embodiment of the invention, said event feature data structure includes data representing the event condition, and data selected from the group consisting of data length of a single event feature, data length of all event features stored in the event feature data structure, data representing an identification of the event feature, and an event feature file identification.

According to yet another preferred embodiment of the invention, the event feature file identification is stored at the end of the file.

According to yet another preferred embodiment of the invention, said digital storage device comprises random access memory.

According to yet another preferred embodiment of the invention, said digital storage device comprises at least one magnetic storage disk drive.

Preferably, said digital storage device comprises a ring buffer for continually storing new video and non-video data in accordance with a predetermined buffer capacity.

According to yet another preferred embodiment of the invention, a playback device is provided for permitting user examination of the stored video and non-video data.

According to another preferred embodiment of the invention, the system includes a triggering device responsive to a user-selected process condition anomaly for copying video files containing data representing the process condition anomaly from the digital storage device into a separate data storage location.

According to yet another preferred embodiment of the invention, the triggering device copies a user-selected number of file segments before and after the video files containing data representing the process condition anomaly from the digital storage device into a separate logical location.

According to yet another preferred embodiment of the invention, the system includes a playback device for permitting user examination of the files copied to the separate storage location.

According to one preferred embodiment of the invention, a process monitoring and event capturing system includes at least one digital video detector for monitoring a process and outputting a digital video signal and at least one digital event signal representing an event condition of the process being monitored, a digital recorder for recording the digital video signal and the digital event signal in a digital video file of a digital storage device having a predetermined data structure. The data structure of the video file comprises a file header at the front of the video file for identifying the file format of the video file, a plurality of chunk headers for identifying the beginning and end of a plurality of frame segments within the video file, and at least one event feature data structure at the end of the video file for storing data representative of the captured event condition.

According to another preferred embodiment of the invention, a process monitoring and event capturing system includes at least one analog video detector for monitoring a process and outputting an analog video signal and at least one analog event signal representing an event condition of the process being monitored, an analog-to-digital converter for converting the analog video signal and the analog event signal into a respective digital video signal and digital event signal; a digital recorder for recording the digital video signal and the digital event signal in a digital video file of a digital storage device having a predetermined data structure. The data structure of the video file includes a file header at the front of the file for identifying the file format of the video file, a plurality of chunk headers for identifying the beginning and end of a plurality of frame segments within the video file, and at least one event feature data structure at the end of the video file for storing data representative of the captured event condition.

An embodiment of the method according to the invention comprises the steps of video monitoring a process, outputting a video signal and at least one event signal representing an event condition of the process being monitored, providing a digital storage device for storing the video signal and the event signal, and providing a digital video file structure on the digital storage device having a file structure that includes a file header at the front of the file for identifying the file format of the video file, a plurality of chunk headers for identifying the beginning and end of a plurality of frame segments within the video file, and at least one event feature data structure at the end of the video file for storing data representative of the captured event condition, recording the video signal and the event signal in the file format of the digital storage device.

According to one preferred embodiment of the invention, the method includes the step of recording a plurality of event feature data structures at the end of the video file.

According to yet another preferred embodiment of the invention, the method includes the step of positioning the plurality of event feature data structures in the video file in time-reversed back-to-front order for permitting additional event feature data structures to be added to the file without alteration of the pre-existing file structure.

According to yet another preferred embodiment of the invention, the method includes the step of positioning a plurality of digital video cameras sequentially along a processing line.

According to yet another preferred embodiment of the invention, the method includes the steps of monitoring the process with a plurality of analog video cameras and converting an analog signal from each of the video cameras into a digital file format for being recorded in the digital storage device.

According to yet another preferred embodiment of the invention, the method includes the step of providing in the digital storage device a temporary data file for storing video segments for examination by the user.

According to yet another preferred embodiment of the invention, the method includes the step of storing the video segments in a sequence corresponding to the sequence of event recording for allowing the user to examine one or more of the video segments in the same sequence as the process.

According to yet another preferred embodiment of the invention, the method includes the step of storing video segments from multiple video sources in a sequence corresponding to the sequence of event recording for allowing the user to examine one or more of the video segments at a single point in time of the process.

According to yet another preferred embodiment of the invention, said event feature data structure includes data representing the event condition, and data selected from the group consisting of data length of a single event feature, data length of all event features stored in the event feature data structure, data representing an identification of the event feature, and an event feature file identification.

According to yet another preferred embodiment of the invention, the method includes the step of storing the event feature file identification at the end of the file.

According to yet another preferred embodiment of the invention, said digital storage device comprises random access memory.

According to yet another preferred embodiment of the invention, the digital storage device comprises at least one magnetic storage disk drive.

According to yet another preferred embodiment of the invention, the step of providing a digital storage device comprises the step of providing a ring buffer for continually storing new video and non-video data in accordance with a predetermined buffer capacity.

According to yet another preferred embodiment of the invention, the method includes the step of providing a playback device for permitting user examination of the stored video and non-video data.

According to yet another preferred embodiment of the invention, the method includes the step of providing a triggering device responsive to a user-selected process condition anomaly for copying video files containing data representing the process condition anomaly from the digital storage device into a separate data storage location.

According to yet another preferred embodiment of the invention, the step of providing a triggering device includes the step of providing a machine vision device for evaluating a video signal and determining whether the signal is within predetermined parameters.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic of a standard AVI file structure;

FIG. 2 is a schematic of a standard AVI file structure showing standard video decoding;

FIG. 3 is a schematic of a conventional ring buffer-type digital storage device;

FIG. 4 is a schematic of an embodiment of an event capturing system (ECS) incorporated into an AVI file structure according to an embodiment of the invention;

FIG. 5 is a schematic of a ring buffer utilizing the ECS file structure;

FIG. 6 is a schematic showing creation of a temporary event coordination file from video data including ECS data captured by a plurality of video cameras and stored in a plurality of ring buffers;

FIG. 7 is a schematic showing ECS data extraction from an ECS modified AVI file structure;

FIG. 8 is a more detailed schematic showing the manner of ECS data extraction from an ECS modified AVI file structure;

FIG. 9 is a block diagram of the overall ECS record mode system;

FIG. 10 is a block diagram of the overall ECS playback/review system; and

FIG. 11 is a representation of a screen allowing simultaneous viewing of a plurality of synchronized ECS-recorded video frames.

### DESCRIPTION OF THE PREFERRED EMBODIMENT AND BEST MODE

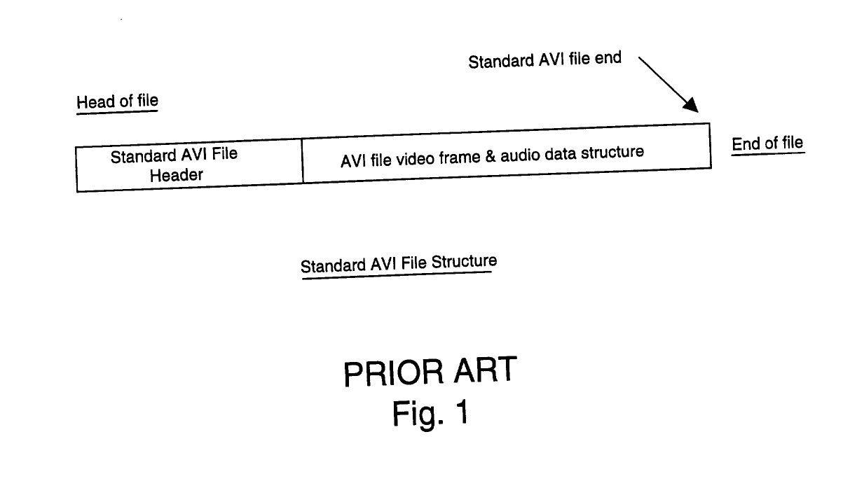

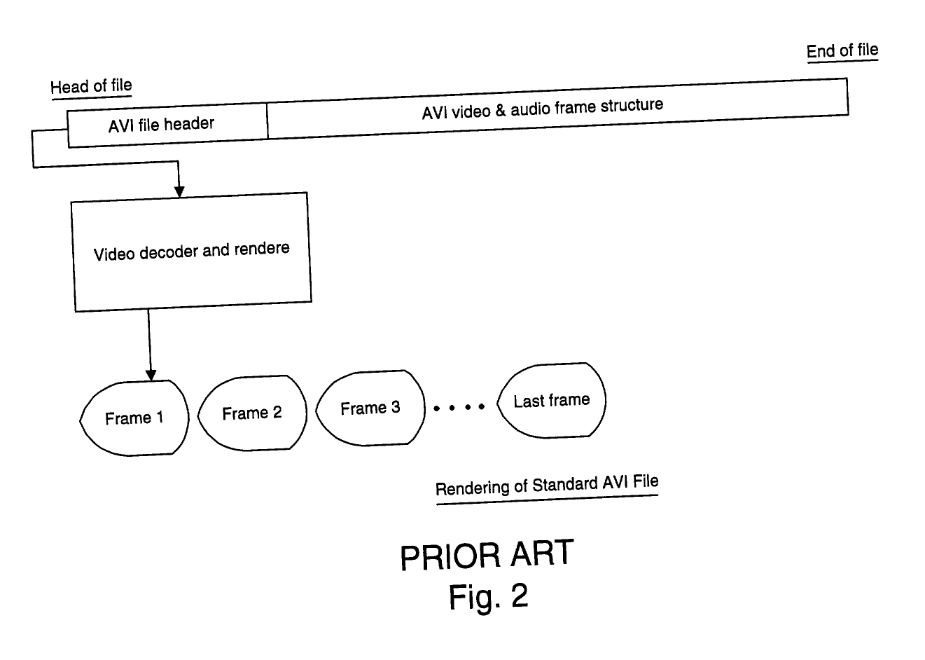

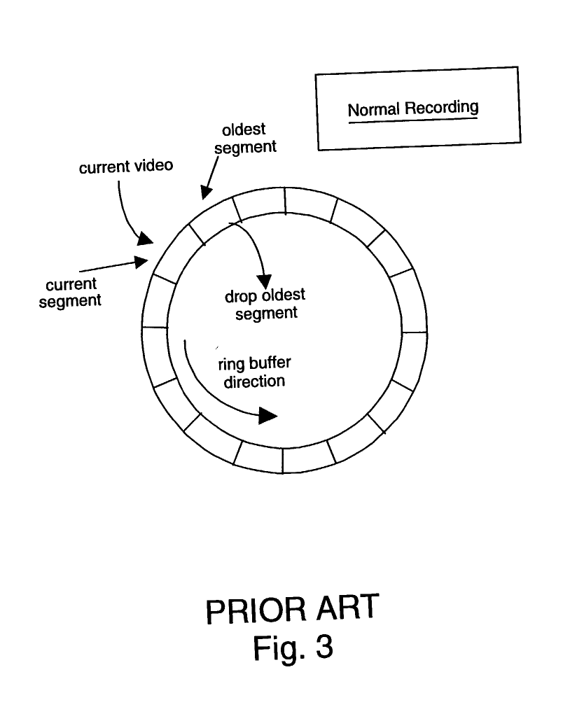

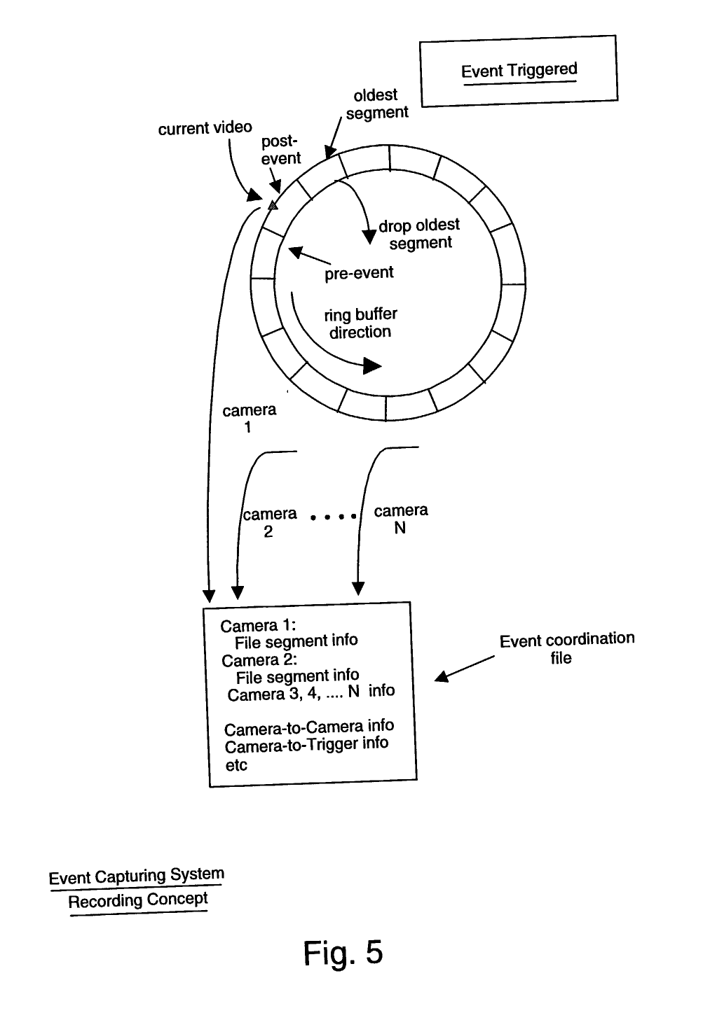

Referring now to the drawings, a preferred embodiment of the invention makes use of a standard AVI file structure, as shown in FIGS. 1 and 2. The standard AVI file structure is modified in a unique manner by attaching ECS data to the end of the standard AVI file structure. This modified AVI file structure is utilized to capture video and other data and record the data in a ring buffer. A conventional ring buffer is shown in FIG. 3, and comprises a data storage device such as an addressable bank of random access memory (RAM) or a disk storage medium. The buffer is configured and sized to hold a predetermined amount of data representing video and related data captured over a predetermined period of time, for example, two hours. The oldest data recorded, for example, two hours earlier, is constantly overwritten with new data so that the buffer always contains the most recent two hours of data, as illustrated in FIG. 5. If an event is triggered, then the file segment information from each camera is stored in a separate text-based file. This text file is used to coordinate the playback of multiple video files.

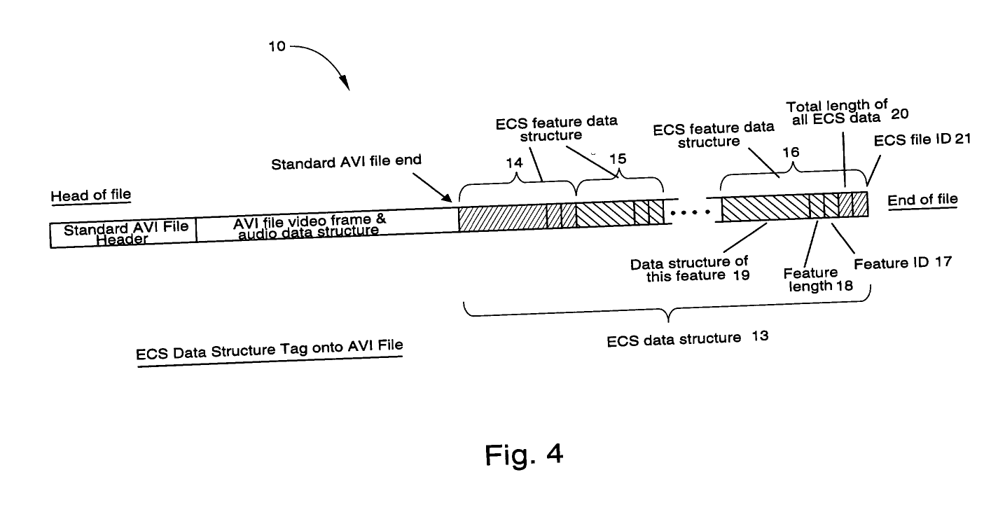

As is shown in FIG. 4, an AVI data structure 10 in accordance with the invention comprises a conventional AVI data structure that is modified by attaching to the end of each data string additional data representing any desired condition or parameter captured during the video recording process. More particularly, video files are recorded based on a trigger input to the ECS system.

The AVI data structure 10 starts with the AVI header structure 11, followed by chunk headers in each data block, as well as the actual video/audio data, indicated at 12. When the AVI file is played back in a video player program, the AVI structure is decoded and the actual video/audio data is read by the program.

When an event occurs, a trigger is sent to the computer. Other vital data can also recorded along with the video data. This data may include the time of the event, the trigger source, and the first frame time. As the file is thereafter being reviewed and analyzed, more information can be added to the file, such as bookmarks and file comments.

To integrate this extra information into the AVI data structure 10 while maintaining the AVI file format integrity so that the modified AVI file can still be rendered on most of the popular software video players, this extra information is placed at the end of the standard AVI data structure 10 as an ESC data structure tag 13 as ESC feature data structures 14, 15 and 16. This enables new features and new information to be added to a standard AVI file. A software program that can read this modified AVI file 10 can extract the extra ESC information in tag 13 from the file, while the standard audio/video portions 12 of the file 10 can also be read by most popular software video players, but without retrieval of the extra ESC tag 13, that is ignored.

Any number of new ECS Feature data structures can be added to the pre-existing AVI file structure 10 later without any change to that data already attached. This is accomplished by attaching a new ECS Feature data structure to the end of the file structure 10, as shown at 16 in FIG. 4. The added ECS feature data structure 16 contains data 17 identifying and distinguishing that particular ECS feature data structure from the others, data 18 identifying the length of the added ECS feature data structure 16, as well as the actual ECS feature data 19.

The length of all the ECS feature data structures 14, 15, 16 is stored at the second to last position 20 from the end of the file, i.e., the immediate position before the ECS file ID 21, that identifies the start of the ECS tag 13.

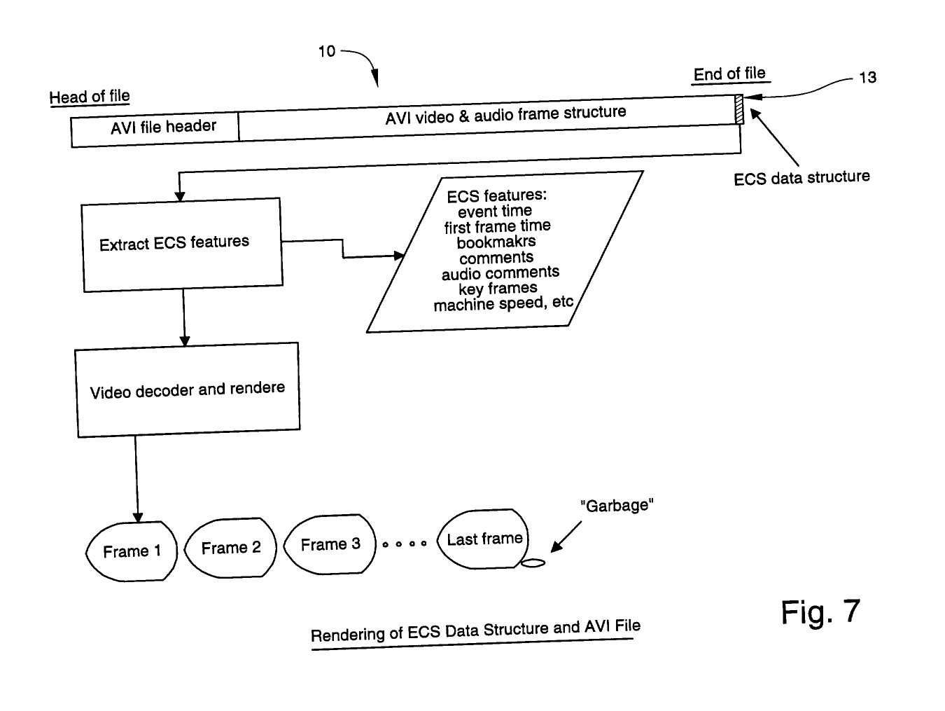

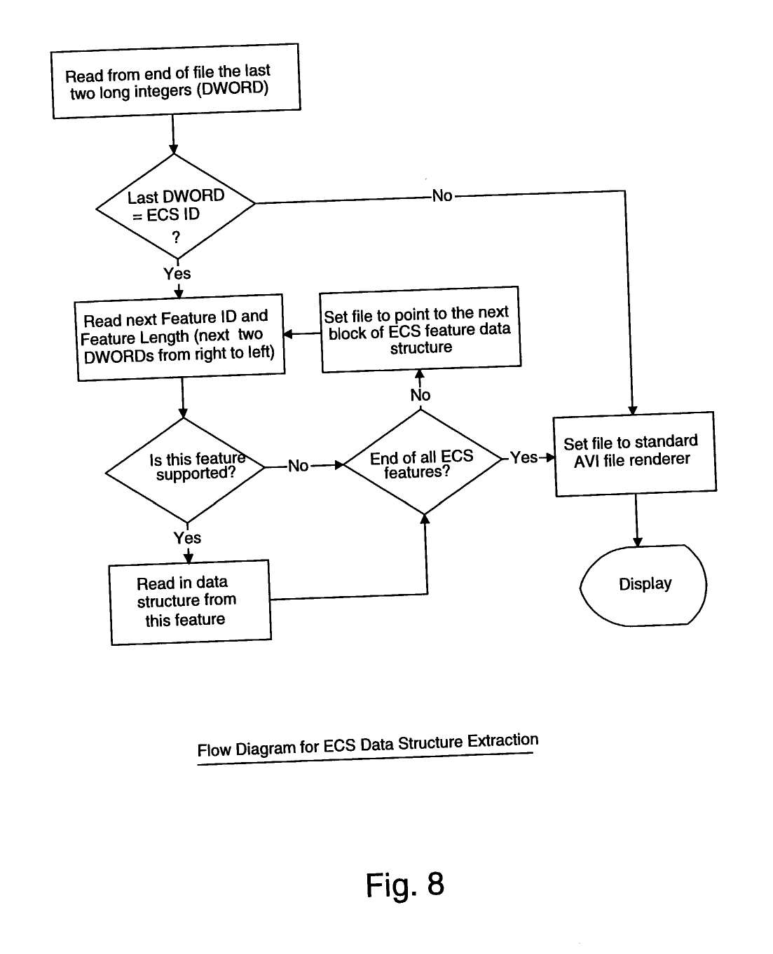

When the video file shown in FIG. 4 is played on a dedicated software video playback and analysis program, the ECS file ID 21 acting as a header, will be read from the end of the file, and each of the ECS Feature data structures 14, 15 and 16 will be read in the backward direction. See FIGS. 7 and 8. The program will first pick up the Feature data structure 16, and then the data 19 within this structure group is read. From this feature data structure 16 the program then moves to the next feature data structure 15 based on the length of the first feature group. If the software is not programmed to pick up a particular feature, the content within this group is simply ignored and the program moves on to the next one. A new feature can be created and placed in the file in this fashion, while disregarding the relative position of this new feature group to the other feature group. Then, the length of the new feature group is added to the original total length stored in the second position from the end so the total length of all the ECS related features is updated. The use of the Feature ID17 and Feature Length 18 make this file structure 10 fully backward compatible and fully expandable.

The video data is then read from the beginning of the data structure 10 as a regular AVI file. The file format shown in FIGS. 4 and 7 can also be read as a regular AVI file by most video players because it has all the standard structure of an AVI file. The ECS data structure 13 attached at the end of the data structure 10 is treated as a small amount of “garbage” (compared to the much larger size of the video data) after the last video frame is displayed, as shown in FIG. 7.

A regular AVI file without any ECS signature (as shown in FIG. 1) created by a non-ECS system, can also be read with the ECS Review program. While playing the regular AVI file, any features like bookmarks and comments (text based or even short audio based) can be added to the end of the file based on this format for later retrieval and use. This format enables any AVI files to be read, and diverse types of data to be tagged at the end of the file without affecting the original file integrity. This data can be tailored to different application needs. For example, a text file tutorial note can be attached to the file, and as this file is played on its intended program, both the video and the tutorial note can be extracted and the tutorial note can be shown alongside the video.

Another application is to attach a key image at the end of the file for quick identification. This technique provides a quick and simple technique to generate a file that blends video and other data together in a single file format. The single file structure greatly enhances the portability and transferability of the file.

This proposed method works not only with the AVI file format, but can be utilized with other video file structures that have a standard file header to identify the type of file format, and chunk headers along segments of the file to identify the beginning and end of several frame sequences. As long as the video file standard does not need to read any format-related information from the end of the file, this novel technique allows other data to be attached onto the standard file format. This is practical because the size of a video file is usually significantly larger than most other kinds of data that would be captured and related to the video file. The extra data structure tag 13 at the end of the file 10 is read without interfering with playback of the video data. See FIG. 8.

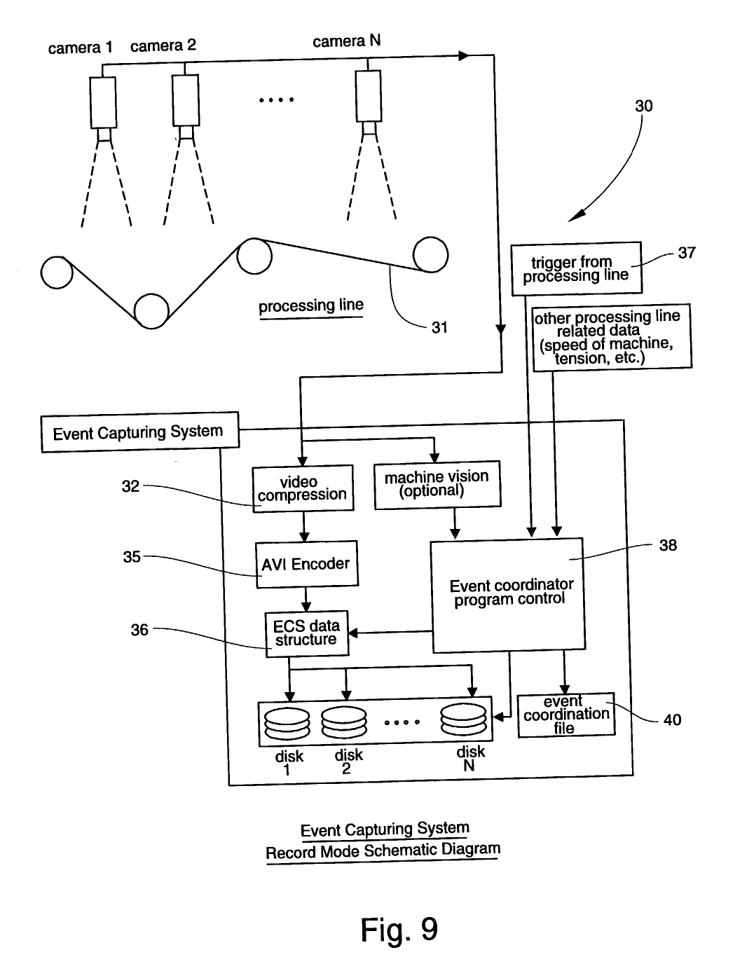

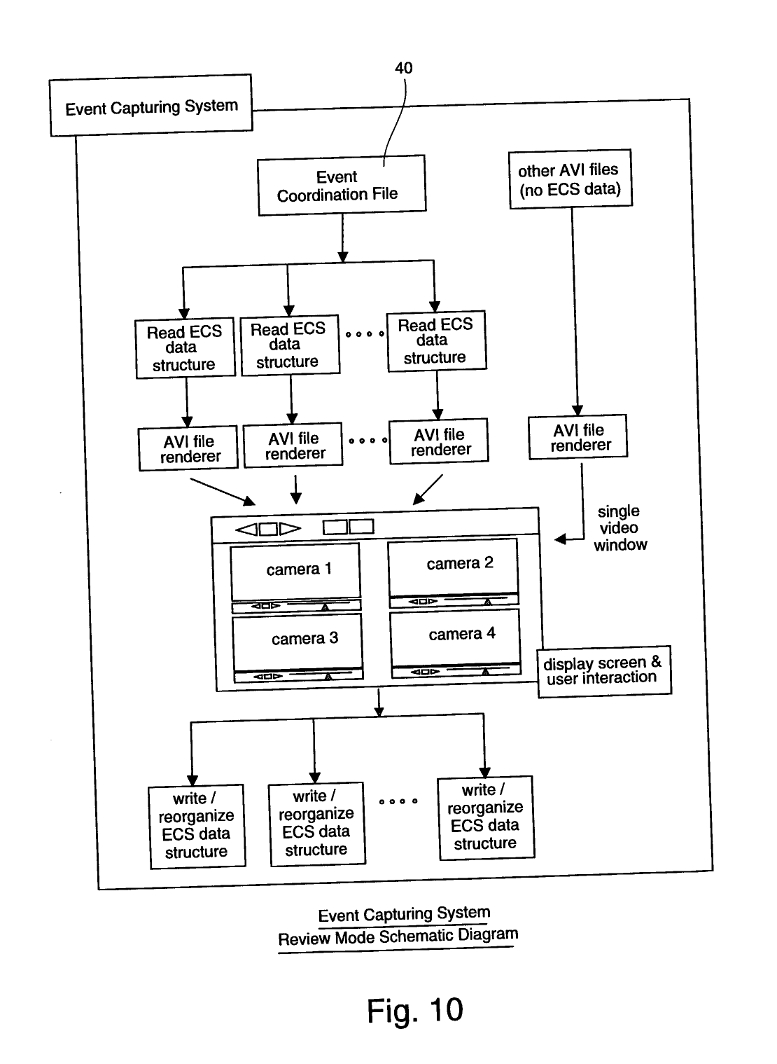

One embodiment of the ECS system described above is disclosed in FIGS. 9 and 10 and indicated broadly at reference numeral 30. Cameras 1-n are positioned along a processing line 31, for example, a conveyor carrying products sequentially through a series of manufacturing process steps, and aimed to record areas of interest within the field of vision of each camera. The field of vision may include particular machines or machine parts, the products being processed, a counter or timer, or processing parameter meters or gauges. As noted above, the cameras may be analog or digital.

The ECS system 30 receives data from the cameras in parallel, optionally splits the signal, and transmits one signal to a video compression circuit 32 and, optionally, the other signal to the machine vision circuit 33 for analysis, as described above. If the signal is an analog signal, the analog signal is converted to a digital signal in an A-to-D converter before compression. A typical compression format is DV25.

The digital data is then encoded by an AVI encoder 35 into an AVI file structure as described above. ECS data is added at an ECS circuit 36 as described above and the data is stored on individual hard disk drives 1-n, formatted to function as ring buffers or, optionally, in RAM storage.

Analysis of the video data occurs in the machine vision circuit 33, and the detection of an event results in a signal output from a trigger 37 to the Event Coordinator Program Control Circuit 38, where a time stamp ECS Feature ID is added to the AVI structure of the frame where the event was detected. As described above, other parameters such as gray scale level or dispersion, motor speeds, pressure, temperatures, etc. can also be converted into ECS data and added to the AVI file structure.

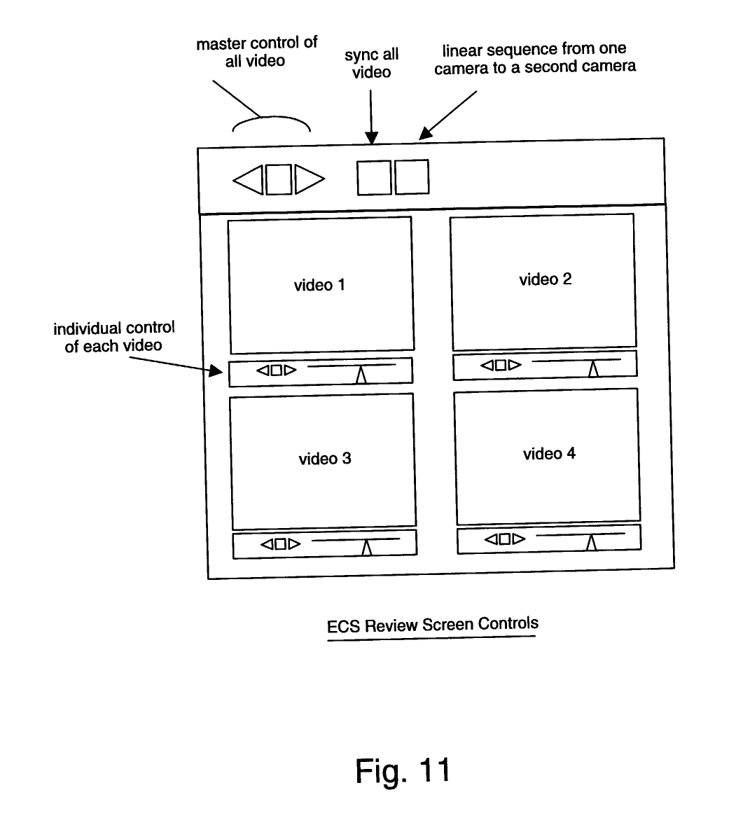

One major advantage of the ECS system is the ability to coordinate the video segments from multiple cameras and to review these video segments as one event. As is shown in FIGS. 10 and 11, the ECS system has the ability to render multiple video files on a single screen, for example, 4 (2×2) windows or 9 (3×3) windows. Each video segment is shown in a window underneath which is a time bar that can include an event mark as well as multiple bookmarks. Moreover, video segments from a camera source can consist of multiple segments. In order to handle all of these multiple video segments as a single event, an event coordination file 40 is generated for each event. This coordination file 40 includes all necessary information so that the review program can treat all of these video segment as a single group and handle it accordingly. Some of this information includes: (1) how many cameras and video segments are involved, (2) the full path of each of these video files segments, (3) the relative distance between each of the cameras so that multiple video segments can be synchronized, (4) the video footage that corresponds to the original trigger source, and (5) the time lag between a trigger signal to a particular camera position. The review process and user interaction relies on event and video footage coordination rather than a simple rendering of multiple video segments on a single screen.

In record mode, FIG. 9, the ECS system is always recording into the video ring buffer. The oldest segment on this ring is replaced with the latest video segment. As mentioned above, when an event arrives, a coordination file 40 is generated so that the user can review multiple video segments as a single event. However, the user may also view any segment of the video footage within the video ring buffer. For multiple camera situations, all of the video segments must be coordinated so that the user can easily navigate through these video segments.

A user may wish to examine video segments which may contain process line anomalies not automatically triggered by an event, for the purpose of defining the conditions by which the machine vision software will trigger an event, or to more closely and clearly examine individual frames of high speed equipment, among others. This is done by viewing frames of video one-by-one within a preselected range and marking a selected frame as an event on a time bar positioned below each window within which a single frame of video is displayed.

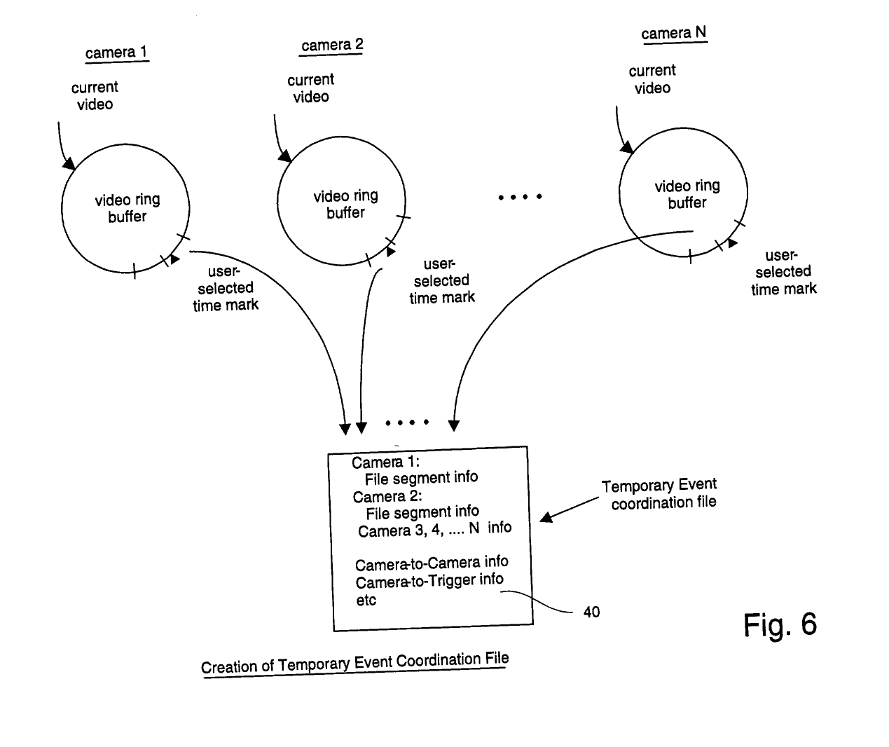

Referring again to FIG. 6, as the user selects a certain time along the ring buffer for further viewing and analysis, the temporary event file 40 is created containing all of the selected the video segments. The structure and content within this event file are identical to that of an actual event file generated by an event trigger signal, as described with reference to FIGS. 5 and 9. This event file is then sent to the review program, FIG. 10, and is processed in the same manner as an actual event. By doing so, all of the selected video segments can be coordinated. The initial time as selected by the user is used as the event time for all these files. The user can also move the event mark while the event is being reviewed. If the user desires to review another time interval along the ring buffer, the temporary event file is simply overwritten and a new temporary event file is created based on the new selected time. If the user desires to save this event, then the temporary event file may be saved in the usual manner. Archives of video segments, whether triggered by the machine vision software or user-selected, may be saved and reviewed to detect and correct not only discrete events, but also long-term variations in processing conditions and parameters which may implicate machine maintenance and/or replacement schedules, quality control practices, employee workloads, and other process-related outcomes.

A video event capturing system and method is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A process monitoring and event capturing system, comprising:
(a) at least one video detector for monitoring a process and outputting a video signal and at least one event signal representing an event condition of the process being monitored;
(b) a recorder for recording the video signal and the event signal in a digital video file of a digital storage device having a predetermined data structure, the video file comprising:
(i) a file header at the front of the file for identifying the file format of the video file;
(ii) a plurality of chunk headers for identifying the beginning and end of a plurality of frame segments within the video file for storing the video signal; and
(iii) at least one event feature data structure at the end of the video file for storing the event signal representative of the captured event condition.

2. A process monitoring and event capturing system according to claim 1, wherein the video file includes a plurality of event feature data structures at the end of the video file.

3. A process monitoring and event capturing system according to claim 2, wherein the plurality of event feature data structures are positioned in the video file in time-reversed back-to-front order for permitting additional event feature data structures to be added to the file without alteration of the pre-existing file structure.

4. A process monitoring and event capturing system according to claim 1, 2 or 3, and including a plurality of digital video cameras for being positioned sequentially along a processing line.

5. A process monitoring and event capturing system according to claim 1, 2 or 3, and including a plurality of analog video cameras and an analog-to-digital converter for converting an analog signal from each of the video cameras into a digital file format for being recorded in the digital storage device.

6. A process monitoring and event capturing system according to claim 1, 2 or 3, and wherein the digital storage device includes a temporary data file for storing video segments for examination by the user.

7. A process monitoring and event capturing system according to claim 6, wherein the video segments are stored in a sequence corresponding to the sequence of event recording for allowing the user to examine one or more of the video segments in the same sequence as the process.

8. A process monitoring and event capturing system according to claim 7, wherein video segments from multiple video sources are stored in a sequence corresponding to the sequence of event recording for allowing the user to examine one or more of the video segments at a single point in time of the process.

9. A process monitoring and event capturing system according to claim 4, wherein said event signal is a non-video signal.

10. A process monitoring and event capturing system according to claim 9, wherein said event feature data structure includes data representing the event condition, and data selected from the group consisting of:
(a) data length of a single event feature;
(b) data length of all event features stored in the event feature data structure;
(c) data representing an identification of the event feature; and
(d) an event feature file identification.

11. A process monitoring and event capturing system according to claim 10, wherein the event feature file identification is stored at the end of the file.

12. A process monitoring and event capturing system according to claim 4, wherein said digital storage device comprises random access memory.

13. A process monitoring and event capturing system according to claim 4, wherein said digital storage device comprises at least one magnetic storage disk drive.

14. A process monitoring and event capturing system according to claim 12, wherein said digital storage device comprises a ring buffer for continually storing new video and non-video data in accordance with a predetermined buffer capacity.

15. A process monitoring and event capturing system according to claim 4, and including a playback device for permitting user examination of the stored video and non-video data.

16. A process monitoring and event capturing system according to claim 4, and including a triggering device responsive to a user-selected process condition anomaly for copying video files containing data representing the process condition anomaly from the digital storage device into a separate data storage location.

17. A process monitoring and event capturing system according to claim 16, wherein said triggering device copies a user-selected number of file segments before and after the video files containing data representing the process condition anomaly from the digital storage device into a separate logical location.

18. A process monitoring and event capturing system according to claim 17, and including a playback device for permitting user examination of the files copied to the separate storage location.

19. A process monitoring and event capturing system, comprising:
(a) at least one digital video detector for monitoring a process and outputting a digital video signal and at least one digital event signal representing an event condition of the process being monitored;
(b) a digital recorder for recording the digital video signal and the digital event signal in a digital video file of a digital storage device having a predetermined data structure, the data structure of the video file comprising:
(i) a file header at the front of the video file for identifying the file format of the video file;
(ii) a plurality of chunk headers for identifying the beginning and end of a plurality of frame segments within the video file; and
(iii) at least one event feature data structure at the end of the video file for storing data representative of the captured event condition.

20. A process monitoring and event capturing system, comprising:
(a) at least one analog video detector for monitoring a process and outputting an analog video signal and at least one analog event signal representing an event condition of the process being monitored;
(b) an analog-to-digital converter for converting the analog video signal and the analog event signal into a respective digital video signal and digital event signal;
(c) a digital recorder for recording the digital video signal and the digital event signal in a digital video file of a digital storage device having a predetermined data structure, the data structure of the video file comprising:
(i) a file header at the front of the file for identifying the file format of the video file;
(ii) a plurality of chunk headers for identifying the beginning and end of a plurality of frame segments within the video file; and
(iii) at least one event feature data structure at the end of the video file for storing data representative of the captured event condition.

21. A method of monitoring a process and capturing a process-associated event, comprising the steps of:
(a) video monitoring a process;
(b) outputting a video signal and at least one event signal representing an event condition of the process being monitored;
(b) providing a digital storage device for storing the video signal and the event signal;
(c) providing a digital video file structure on the digital storage device having a file structure including:
(i) a file header at the front of the file for identifying the file format of the video file;
(ii) a plurality of chunk headers for identifying the beginning and end of a plurality of frame segments within the video file;
(iii) at least one event feature data structure at the end of the video file for storing data representative of the captured event condition; and
(d) recording the video signal and the event signal in the file format of the digital storage device.

22. A method according to claim 21, and including the step of recording a plurality of event feature data structures at the end of the video file.

23. A method according to claim 22, and including the step of positioning the plurality of event feature data structures in the video file in time-reversed back-to-front order for permitting additional event feature data structures to be added to the file without alteration of the pre-existing file structure.

24. A method according to claim 21, 22 or 23, and including the step of positioning a plurality of digital video cameras sequentially along a processing line.

25. A method according to claim 21, 22 or 23, and including the steps of monitoring the process with a plurality of analog video cameras and converting an analog signal from each of the video cameras into a digital file format for being recorded in the digital storage device.

26. A method according to claim 21, 22 or 23, and including the step of providing in the digital storage device a temporary data file for storing video segments for examination by the user.

27. A method according to claim 26, and including the step of storing the video segments in a sequence corresponding to the sequence of event recording for allowing the user to examine one or more of the video segments in the same sequence as the process.

28. A method according to claim 27, and including the step of storing video segments from multiple video sources in a sequence corresponding to the sequence of event recording for allowing the user to examine one or more of the video segments at a single point in time of the process.

29. A method according to claim 28, wherein said event signal is a non-video signal.

30. A method according to claim 29, wherein said event feature data structure includes data representing the event condition, and data selected from the group consisting of:
(a) data length of a single event feature;
(b) data length of all event features stored in the event feature data structure;
(c) data representing an identification of the event feature; and
(d) an event feature file identification.

31. A method according to claim 30, and including the step of storing the event feature file identification at the end of the file.

32. A method according to claim 31, wherein said digital storage device comprises random access memory.

33. A method according to claim 31, wherein said digital storage device comprises at least one magnetic storage disk drive.

34. A method according to claim 32, wherein the step of providing a digital storage device comprises the step of providing a ring buffer for continually storing new video and non-video data in accordance with a predetermined buffer capacity.

35. A method according to claim 34, and including the step of providing a playback device for permitting user examination of the stored video and non-video data.

36. A method according to claim 21, and including the step of providing a triggering device responsive to a user-selected process condition anomaly for copying video files containing data representing the process condition anomaly from the digital storage device into a separate data storage location.

37. A method according to claim 36, wherein the step of providing a triggering device includes the step of providing a machine vision device for evaluating a video signal and determining whether the signal is within predetermined parameters.
